(19) United States
(12) Patent Application Publication
(10) Pub. No.: US 2012/0031215 A1
(43) Pub. Date: Feb. 9, 2012

(54) TRANSMISSION UNIT

(75) Inventor: Bernhard Feier, Ligist (AT)

(73) Assignee: MAGNA Powertrain AG & Co KG, Lannach (AT)

(21) Appl. No.: 13/256,489

(22) PCT Filed: Dec. 28, 2009
(86) PCT No.: PCT/EP2009/009291

§ 371 Date: Nov. 1, 2011

(30) Foreign Application Priority Data
Mar. 24, 2009 (DE) 10 2009 014 595.8

(51) Int. Cl. F16H 59/00

(52) U.S. Cl. 74/473.12

(57) ABSTRACT

A transmission for a motor vehicle including a transmission housing for receiving a transmission and an actuator for actuating the transmission. The actuator comprises an electric motor having a stator, a rotor, and a drive shaft protruding into an interior of the transmission housing. The actuator further comprises a control circuit for controlling the electric motor, and a heat sink device thermally conductively coupled to the control circuit. The stator of the electric motor is directly attached to the transmission housing. The heat sink device is attached to the transmission housing independently of the mounting of the stator.

### CROSS-REFERENCE TO RELATED APPLICATIONS

This application is a National Stage of International Application No. PCT/EP2009/009291, filed Dec. 28, 2009. This application claims the benefit and priority of German Patent Application No. 10 2009 014 595.8 filed Mar. 24, 2009. The entire disclosures of each of the above applications are incorporated herein by reference.

### FIELD

The present disclosure relates to a transmission unit for a motor vehicle having a transmission housing for receiving a transmission and having an actuator for actuating the transmission. The actuator includes an electric motor having a stator, a rotor, and a drive shaft which projects into an inner space of the transmission housing. The actuator furthermore includes a control circuit (for example, a circuit board having a plurality of electronic components) for controlling the electric motor. In addition, the actuator includes a heat sink device (for example, a metal plate having cooling ribs), which is thermally coupled to the control circuit.

### BACKGROUND

A transmission unit can include a transfer case for transferring a driving torque in the longitudinal direction of the vehicle (i.e., for transferring a driving torque selectively to the front axle or to the rear axle of the vehicle). Such transfer cases are known in different embodiments (for example, having a lockable differential gear, or having a variable torque transmission device). The transmission unit can in particular include a friction clutch that is actuated by means of the actuator. A transmission unit is, for example, known from WO 2006/128533 A1 in which an electric motor drives two ramp rings to make a rotary movement via a control cam and two scissor linkages actuated thereby in order hereby to actuate a friction clutch, wherein the friction clutch selectively transmits a portion of the driving torque to a secondary axle of the vehicle.

High heat development can occur in both the electric motor and the control circuit during operation of the actuator. It is, therefore, known to couple the electric motor thermally conductively to the transmission housing, which is usually formed from metal, so that the transmission housing for the electric motor serves as a heat sink. The control circuit, in contrast, is thermally conductively coupled to a separate heat sink device so that a different temperature level can be adopted in this separate heat sink device than with respect to the transmission housing in order effectively to avoid an overheating of the electronic components of the control circuit.

Such arrangements are known from EP 1 640 204 A2, DE 100 10 636 A1, and U.S. Pat. No. 7,215,115 B2. In this respect, the actuator is typically at least partly arranged in an actuator housing whose front side is flanged to the transmission housing. The heat sink device for the control circuit is located at the rear side of the actuator housing in this embodiment. A good thermal insulation of the heat sink device of the control circuit from the transmission housing can be achieved. However, the vibrations that usually occur in the operation of a transmission unit can prove to be problematic. Since the heat sink device of the control circuit is typically formed by a comparatively heavy metal plate and is arranged at a specific spacing from the transmission housing due to the interposition of the actuator housing, the vibrations of the transmission can result in unwanted vibrations of the heat sink device and of the control circuit associated herewith, whereby resonant effects can arise. There is, therefore, the risk of a curtailed service life of the control circuit.

### SUMMARY

The present disclosure provides a transmission unit having an actuator that has good heat insulation and simultaneously good vibration resistance.

This is satisfied by a transmission unit where a stator of the electric motor is directly fastened to the transmission housing, and where the heat sink device of the control circuit is fastened to the transmission housing independently of the fastening of the stator.

In the transmission unit in accordance with the present disclosure, the stator of the electric motor is directly fastened to the transmission housing. It is hereby ensured that the heat output produced in the electric motor can be effectively transmitted to the transmission housing which, therefore, serves as a heat sink for the electric motor. The heat sink device of the control circuit is not fastened to the transmission housing indirectly via the stator of the electric motor, but rather independently of the fastening of the stator. The heat sink device is hereby particularly well thermally insulated from the electric motor. In addition, the heat sink device of the control circuit can be fastened particularly rigidly to and at a small spacing from the transmission housing. Lever effects are hereby avoided that can result in unwanted resonant amplifications of vibrations of the transmission housing. The transmission unit in accordance with the present disclosure is thus characterized by an improved vibration resistance with respect to the heat sink device and the control circuit associated herewith.

Thermal insulation of the heat sink device of the control circuit from the transmission housing can be realized by the heat sink device is not being directly fastened to the transmission housing, but rather by means of a thermal insulation device. This thermal insulation device can, for example, be a plastic plate that extends between the heat sink device of the control circuit and the transmission housing.

The required electric connection between the control circuit and the stator of the electric engine can, in contrast, take place via electrical contacts (preferably plug-in contacts) that, however, do not satisfy any mechanical support functions and also do not effect any substantial heat transfer.

In accordance with a particularly advantageous embodiment, the transmission housing has a recess, with the stator of the electric motor being arranged at the base of the recess and with the heat sink device of the control circuit forming a cover for the recess of the transmission housing. In other words, the transmission housing in this embodiment has (viewed from the outside) a concave section which receives the stator of the electric motor so that no separate housing is required for the electric motor. The heat sink device provided for the control circuit can form a cover so that the recess can be closed after fastening the stator to the transmission housing without any additional components being required.

The heat sink device of the control circuit can be substantially made in plate form to form a flat cover for the recess of the transmission housing. In this manner, a particularly rigid mechanical connection is possible between the heat sink device and the transmission housing without projecting masses so that resonant amplifications of vibrations of the transmission housing are effectively avoided.

An opening through which the drive shaft of the electric motor projects into the inner space of the transmission housing can be provided at the base of the named recess of the transmission housing.

To prevent oil from entering into the region of the electric motor from the inner space of the transmission housing, a seal device such as a radial shaft seal can be arranged at the drive shaft.

For sealing contaminations from outside, sealing lips that contact the transmission housing can be provided that are molded onto the thermal insulation device. The region of the electric motor and the adjoining inner space of the transmission housing are, therefore, hereby sealed with respect to the environment. The molded on sealing lips provide a particularly effective protection if the transmission housing has the recess and the thermal insulation device partly projects with the sealing lips into the recess.

The rotor of the electric motor can be directly fastened to the drive shaft by, for example, pressing the rotor onto the drive shaft, which projects into the inner space of the transmission housing. Unlike transmission actuators that have a separate actuator housing in a modular construction, a separate motor shaft and a coupling between such a motor shaft and the drive shaft can hereby be omitted. Furthermore, an additional bearing for the drive shaft can be omitted by such an integrated structure.

It is furthermore advantageous if at least one permanent magnet is arranged at the drive shaft of the electric motor concentrically to the axis of rotation of the drive shaft with the control circuit having at least one sensor for detecting an angular position of the permanent magnet and thus of the drive shaft, with the sensor also being arranged concentric to the axis of rotation of the drive shaft. The signal of the sensor can be used for at least one of the commutation of the electric motor and for a position regulation of the actuator. A sufficiently high resolution of the angular position can be achieved by the arrangement of the permanent magnet at the drive shaft (i.e., not, for instance, radially spaced apart therefrom) using a single permanent magnet and thus with a particularly simple structure.

A particularly simple structure of the actuator results when the drive shaft of the electric motor is made as a worm shaft that cooperates with a worm wheel that forms a ramp ring for actuating a friction clutch of the transmission unit. A particularly short actuator chain can be formed in this manner that, nevertheless, allows a high stepping down of the speed of the electric motor.

### DRAWING

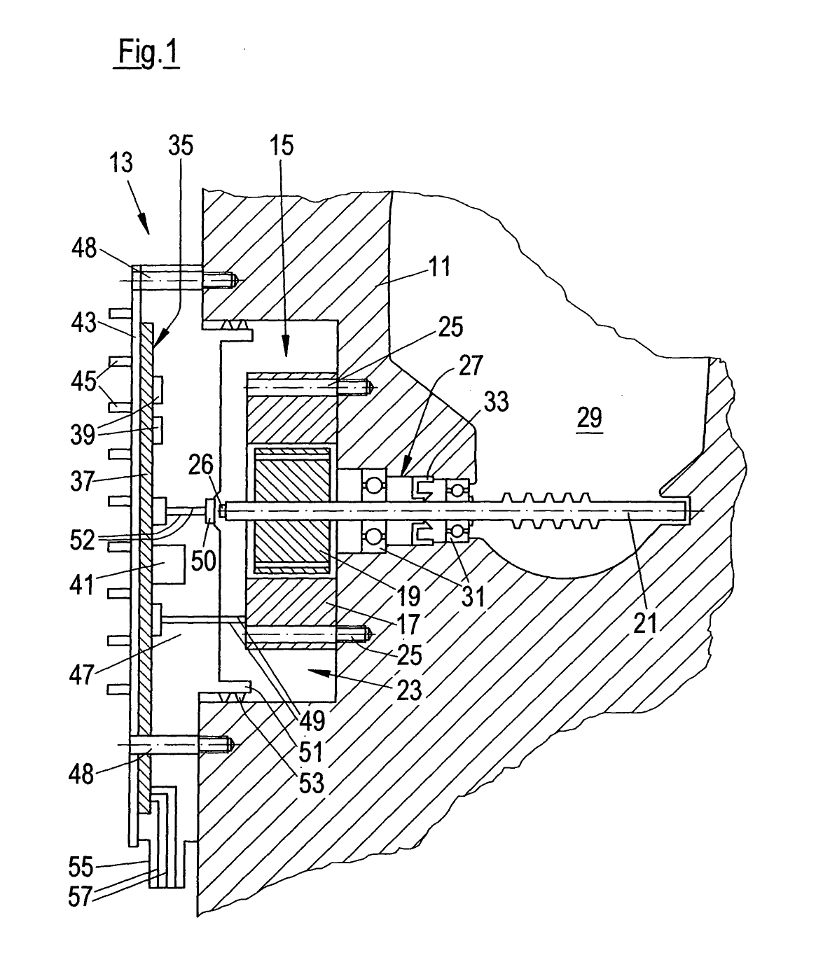

The detailed description of the present disclosure will be described in the following only by way of example with reference to the drawing. The FIGURE (FIG. 1) shows a schematic cross-sectional view of a part of a transmission unit for a motor vehicle.

### DETAILED DESCRIPTION

This transmission unit can include a transfer case, not shown in the FIGURE, as is generally known from the initially already named WO 2006/128533 A1.

Referring to FIG. 1, the transmission unit includes a transmission housing 11, only shown in part, for receiving the transmission (not shown) and an actuator 13 for actuating the transmission. The actuator 13 includes an electric motor 15 having a stator 17, a rotor 19 and a drive shaft 21. The electric motor 15 is made as a brushless DC motor (BLDC motor). The electric motor 15 is arranged within a cylindrical recess 23 of the transmission housing 11, with the stator 17 being fastened to the base of the recess 23 by means of two screws 25. The transmission housing 11 can be formed in multiple parts. The transmission housing 11, however, surrounds the recess 23 peripherally in one part in the region of the electric motor 15. The rotor 19 is pressed onto the drive shaft 21. A bipolar permanent magnet 26 can be fastened to the end of the drive shaft 21 disposed in the recess 23 at the end face of the drive shaft 21 and thus concentrically to the axis of rotation of the drive shaft 21.

The drive shaft 21 of the electric motor 15 is made as a worm shaft. The drive shaft 21 projects through an opening 27 at the base of the recess 23 into the inner space 29 of the transmission housing 11. The drive shaft 21 is in this respect rotatably supported at the transmission housing 11 by means of two bearings 31 that are formed as ball bearings, with the two bearings 31 being axially offset from one another. A radial shaft sealing ring 33 can be arranged between the two bearings 31 and seals the region of the electric motor 15 (recess 23) with respect to the lubrication oil present in the inner space 29 of the transmission housing 11.

The actuator 13 furthermore includes a control circuit 35 for controlling the electric motor 15. The control circuit 35 has a circuit board 37 at which a plurality of electronic components 39 (e.g., a capacitor 41) are provided. The actuator 13 further includes a heat sink device 43 which is formed from metal and has a plurality of cooling ribs 45. The heat sink device 43 is thermally conductively coupled to the control circuit 35, in particular by direct contact or due to an interposed thermally conductive paste.

The heat sink device 43 is fastened to the transmission housing 11 by means of a plurality of screws 48 via a plate-shaped heat insulation device 47 made from plastic, and indeed independently of the fastening of the stator 17 of the electric motor 15 to the transmission housing 11. Only an electric connection is provided between the stator 17 and the control circuit 35 via a plurality of electric plug-in contacts 49.

The control circuit 35 further includes a Hall sensor 50 which is arranged in an opposite position to the permanent magnet 26 concentrically to the axis of rotation of the drive shaft 21 and the permanent magnet 26. The Hall sensor 50 contactlessly detects the angular position of the permanent magnet 26 and thus of the drive shaft 21. The Hall sensor 50 is embedded in the heat insulation device 47 and is electrically connected via a plurality of plug-in contacts 52 to the circuit board 37 or to the component 39 fastened hereto.

Since the heat sink device 43 is also made substantially in plate form (with the exception of the cooing ribs 45), the heat sink device 43 forms, together with the heat insulation device 47, a flat cover for the recess 23 of the transmission housing 11.

Molded-on sealing lips 53 which contact the transmission housing 11 and outwardly seal the electric motor 15 are provided at a flange 51 of the heat insulation device 47 which projects into the recess 23 of the transmission housing 11.

A connector plug 55 is shaped at the heat insulation device 47 and includes a plurality of electric connections 57 which are led to the control circuit 35, to allow a power supply and a communication with a central control unit of the vehicle.

The transmission unit shown has the advantage that the stator 17 of the electric motor 15 is directly fastened to the transmission housing 11 within the recess 23 so that no separate motor housing is required. The heat sink device 43 is fastened to the transmission housing 11 via the heat insulation device 47 independently of the electric motor 15, with the control circuit 35 being arranged between the heat sink device 43 and the heat insulation device 47. The control circuit 35 is thus particularly well thermally insulated from the electric motor 15. In addition, a particularly rigid mechanical connection is ensured between the control circuit 35 and the transmission housing 11 so that a large spacing of the comparatively heavy heat sink device 43 from the transmission housing 11 (for instance due to an interposition of the electric motor 15 or of a motor housing) is avoided and vibrations of the transmission housing 11 thus do not result in unwanted resonant effects.

A further advantage of this arrangement is that the rotor 19 of the electric motor 15 is directly fastened to the drive shaft 21 which projects into the inner space 29 of the transmission housing 11. A two-part drive shaft 21 having a corresponding couponing device and additional bearings 31 is thus not necessary, whereby additional components are saved.

A particular advantage of the arrangement shown is also that the control circuit 35 is at least partly integrated into the heat insulation device 47. The components 39 provided at the circuit board 37 are hereby supported by the heat insulation device 47 so that damage to the control circuit 35 due to the total vibrations of the transmission housing 11 is effectively avoided. It is particularly effective if the heat insulation device 47 is made from plastic and at least a part of the control circuit 35 is overmolded by the heat insulation device 47. This in particular applies with respect to the capacitor 41 which is usually the heaviest component of the control circuit 35 and which is thus particularly prone to damage due to the named vibrations.

1-21. (canceled)

22. A transmission unit for a motor vehicle having a transmission housing for receiving a transmission and an actuator for actuating the transmission, the actuator includes an electric motor having a stator, a rotor and a drive shaft which projects into an inner space of the transmission housing, a control circuit for controlling the electric motor, and a heat sink device which is thermally conductively coupled to the control circuit, and wherein the stator of the electric motor is directly fastened to the transmission housing and the heat sink device is fastened to the transmission housing independently of the fastening of the stator.

23. The transmission unit in accordance with claim 22, wherein the transmission housing has a recess, wherein the stator of the electric motor is arranged at the base of the recess, and wherein the heat sink device forms a cover for the recess of the transmission housing.

24. The transmission unit in accordance with claim 23, wherein the heat sink device is made in plate form to form a flat cover for the recess of the transmission housing.

25. The transmission unit in accordance with claim 23, wherein the recess of the transmission housing has a cylindrical shape.

26. The transmission unit in accordance with claim 23, wherein the transmission housing has an opening at the base of the recess through which the drive shaft of the electric motor projects into the inner space of the transmission housing.

27. The transmission unit in accordance with claim 23, wherein a sealing device is provided between the inner space and the recess of the transmission housing.

28. The transmission unit in accordance with claim 27, wherein the sealing device is a radial shaft sealing ring.

29. The transmission unit in accordance with claim 22, wherein the rotor of the electric motor is fastened to the drive shaft,

30. The transmission unit in accordance with claim 22, wherein at least one permanent magnet is connected to the drive shaft concentrically to the axis of rotation of the drive shaft, wherein the control circuit has at least one sensor for detecting an angular position of the permanent magnet, and wherein the sensor is arranged concentric to the axis of rotation of the drive shaft.

31. The transmission unit in accordance with claim 22, wherein the drive shaft of the electric motor is supported at the transmission housing by means of at least two bearings, with the two bearings being axially offset from one another.

32. The transmission unit in accordance with claim 22, wherein the drive shaft of the electric motor is formed as a worm shaft.

33. The transmission unit in accordance with claim 22, wherein the heat sink device is made from metal and includes cooling ribs.

34. The transmission unit in accordance with claim 22, wherein the heat sink device is fastened to the transmission housing via a heat insulation device.

35. The transmission unit in accordance with claim 34, wherein the heat insulation device is made in plate form and extends between the heat sink device and the transmission housing.

36. The transmission unit in accordance with claim 34, wherein the heat insulation device is made from plastic and has molded on lips which contact the transmission housing.

37. The transmission unit in accordance with claim 34, wherein the control circuit is at least partly integrated into the heat insulation device.

38. The transmission unit in accordance with claim 34, wherein the heat insulation device is made from plastic and a part of the control circuit is overmolded by the heat insulation device.

39. The transmission unit in accordance with claim 38, wherein the part of the control circuit overmolded by the heat insulator device is a capacitor.

40. The transmission unit in accordance with claim 22, wherein the control circuit has a circuit board.

41. The transmission unit in accordance with claim 22, wherein the control circuit is connected to the stator of the electric motor via a plurality of electric plug contacts (49).

42. The transmission unit in accordance with claim 22, wherein the transmission unit has a transfer case for transferring a drive torque in the longitudinal direction of the vehicle.

43. A transmission unit for a motor vehicle comprising:
a transmission housing having an inner space receiving a transmission, an outer recess and an opening extending between the inner space and the outer recess;
an electric motor disposed within the outer recess and including a stator secured to the transmission housing, a rotor, and a drive shaft fixed for rotation with the rotor and extending through the opening so as to project into the inner space;
a control circuit for controlling the electric motor; and
a heat sink device thermally conductively connected to the control circuit and secured to the transmission housing to enclose the outer recess.

44. The transmission unit of claim 43, wherein the opening extends through a base position of the outer recess, wherein the stator is directly secured to the base portion, and wherein the heat sink device cooperates with a heat insulation device to form a cover for the recess so as to enclose the electric motor therein.

45. The transmission unit of claim 44, wherein the control circuit includes a circuit board disposed between the heat sink device and the heat insulation device and electrically connected to the stator.

46. The transmission unit of claim 45, wherein the circuit board has a flat surface thermally conductively connected to the heat sink device and a second surface to which a plurality of electronic components are mounted, and where at least one of the electronic components is supported by the heat insulation device.

47. A transmission unit for a motor vehicle comprising:
a transmission housing defining an inner space receiving a transmission, an outer recess, a wall portion extending between the inner space and the outer recess, and an opening extending through the wall portion; and
an actuator including an electric motor, a control circuit and a cover
wherein the electric motor includes an annular stator directly secured to a base surface of the outer recess, a rotor disposed within the stator, and a drive shaft having a first portion fixed to the rotor and a second portion extending through the opening so as to project into the inner space,
wherein the control circuit includes a circuit board in electrical connection with the stator, and
wherein the cover is secured to the transmission housing to enclose the center recess and includes a thermal sink device that is thermally conductively connected to the circuit board.

48. The transmission unit of claim 47, wherein the cover further includes a heat insulation device disposed between the circuit board the electric motor.

49. The transmission unit of claim 48, wherein the circuit board has a flat surface thermally conductively connected to the heat sink device and a second surface to which a plurality of electronic components are mounted, and wherein at least one of the electronic components is supported by the heat insulation device.
